(19) United States
(12) Patent Application Publication
(10) Pub. No.: US 2025/0037221 A1
(43) Pub. Date: Jan. 30, 2025

(54) APPARATUSES, METHODS, AND COMPUTER PROGRAM PRODUCTS FOR PROPERTY-BASED TRANSACTIONS

(71) Applicant: Wells Fargo Bank, N.A., San Francisco, CA (US)

(72) Inventors: Parul GHOSH, Bangalore (IN); Kourtney EIDAM, Marietta, GA (US); Kristine Ing KUSHNER, Orinda, CA (US)

(21) Appl. No.: 17/569,038

(22) Filed: Jan. 5, 2022

(51) Int. Cl. G06Q 50/16; G06Q 30/06

(52) U.S. Cl. CPC G06Q 50/167; G06Q 30/0609; G06Q 30/0627

(57) ABSTRACT

A method, apparatus, and computer program product for property-based transactions are provided. An example method includes receiving, by a computing device, a property-based transaction request of a first user that includes first selection parameters and determining first user characteristics of the first user associated with the property-based transaction request. The method further includes determining a first candidate real estate owned (REO) property data object based upon the first selection parameters and the first user characteristics. The first candidate REO property data object is indicative of a first physical location that is owned by an entity associated with the computing device. The method further includes providing a first actionable object to the first user for the first candidate REO property data object. The first actionable object includes selectable inputs that receive corresponding first user inputs for effectuating a transaction that results in a transfer of ownership of the first physical location.

### TECHNOLOGICAL FIELD

Example embodiments of the present disclosure relate generally to device communication and, more particularly, to data object generation and associated management amongst devices for property-based transactions.

### BACKGROUND

Real property assets are regularly purchased, sold, transferred, financed, and/or the like by a variety of entities or institutions (e.g., consumers, financial institutions, real estate investment trusts (REITs), private equity firms, real estate agents, etc.). For consumers, the selection and purchase of real property in the form of a home or the like is often one of the largest purchases in monetary value experienced by these consumers. The process, however, to identify real property assets for purchase as well as the process associated with, for example, financing purchase of the same is often burdensome to consumers and institutions alike.

### BRIEF SUMMARY

As described above, real property assets are regularly the subject of purchases, sales, transfers, or other interactions amongst consumers, financial institutions, and/or the like. As such, real property in the form of a house or home (e.g., real estate) located at a physical location may be sought and subsequently purchased by a consumer. In many instances, however, the process of identifying, for example, a potential house for purchase is riddled with complexities for the potential buyer including locating the potential house, completing required requests or documentation to receive funding to purchase the house, rendering an offer for the house that is ultimately accepted by a seller, and/or the like. Similarly, financial institutions or any entity involved in real property transactions may be equally burdened during the process due to the resources leveraged to facilitate the various subprocesses (e.g., verification, underwriting, valuation, inspection, etc.) associated with funding a transaction. For example, various computing systems of an example financial institution may be severely burdened (e.g., processing limitations, memory requirements, etc.) in performing these subprocesses for potential real property transactions that may never come to fruition.

Additionally, financial institutions may also own real property, such as houses, located at physical locations. By way of example, financial institutions or other lenders may own real estate owned (REO) properties that result from unsuccessful foreclosure auctions or other default actions (e.g., depressed real estate assets or the like). These REO properties are often difficult for financial institutions to sell and/or result in financial losses on the part of the financial institution during such a sale. Furthermore, the computational resources employed by these financial institutions in maintaining, updating, transferring, transmitting, and/or performing operations associated data entries of these REO properties is substantial. This burden may be further increased by the difficulties described above regarding property transactions (e.g., verification, underwriting, inspection, and/or the like). Therefore, conventional systems for property-based transactions are often slow to perform necessary processes and subprocesses, from a consumer perspective as well as from a computing system perspective and further fail to properly address the nuanced technical constraints associated with REO properties.

To solve these issues and others, example implementations of embodiments of the present disclosure may generate and maintain candidate real estate owned (REO) property data objects for particular users and/or for a plurality of properties (e.g., REO properties owned by an entity of the present disclosure). In operation, the embodiments described herein may receive property-based transaction requests from a plurality of users each of which may include selection parameters that are indicative of a type, value, location, etc. associated with a real property asset. One or more characteristics of the requesting user (e.g., net worth, credit score, etc.) may be determined, and a respective REO property data object may be generated that is indicative of a physical location that is owned by an entity associated with the described system. The REO property data object of the present disclosure may operate to store, perform, stage, or otherwise complete necessary processes or subprocesses for effectuating a property-based transaction that transfers ownership of the associated physical location indicated by the first candidate REO property data object to the appropriate user. In doing so, the embodiments described herein may reduce the computational burdens (e.g., processing limitations, memory requirements, etc.) associated with traditional systems. Furthermore, the REO property data objects described herein may operate to offload or otherwise expeditiously attend to the selling of REO properties that would otherwise require additional resources to maintain. Still further, by providing REO property data objects to a plurality of users associated with the same or different underlying physical locations, the embodiments described herein may operate to minimize the time require for a particular user to purchase a property by, in parallel, precluding transactions by other users.

In this way, the inventors have identified that the advent of computing resources have created a new opportunity for solutions for property-based transactions and associated data storage which were historically unavailable. In particular, the embodiments herein may operate to address several technical challenges including: (1) minimizing the computational burden of payment systems, (2) minimizing operating time for payment based processes and subprocesses, and (3) providing dynamically modifiable data objects for transitioning ownership of real property assets, particularly those owned by the underlying entity associated with the system.

Systems, apparatuses, methods, and computer program products are disclosed herein for property-based transactions. In one embodiment, with reference to the claimed computer-implemented method, a method for property-based transactions is provided. The method may include receiving, by a computing device, a property-based transaction request associated with a first user where the property-based transaction request includes one or more first selection parameters and determining one or more first user characteristics of the first user associated with the property-based transaction request. The method may further include determining a first candidate real estate owned (REO) property data object based upon the one or more first selection parameters and the one or more first user characteristics where the first candidate REO property data object is indicative of a first physical location that is owned by an entity associated with the computing device. The method may further include providing a first actionable object to the first user for the first candidate REO property data object, wherein the first actionable object comprises one or more selectable inputs configured to receive one or more corresponding first user inputs for effectuating a transaction that results in a transfer of ownership of the first physical location indicated by the first candidate REO property data object to the first user.

In some embodiments, determining the one or more first user characteristics of the first user associated with the property-based transaction request further includes querying a user account database and determining if an account associated with the first user is present in the user account database. In an instance in which the account associated with the first user is present in the user account database, the method may include acquiring the one or more first user characteristics of the first user from the user account database. In an instance in which the account associated with the first user is absent from the user account database, the method may include requesting a user input of the one or more first user characteristics.

In some embodiments, providing the first actionable object to the first user further includes transmitting the first actionable object to a first user device associated with the first user via a first transmission.

In some further embodiments, the method may include transmitting a second transmission to a second user device associated with a second user. The second transmission may include instructions to preclude input of one or more second user inputs via a second actionable object so as to prevent a transaction that results in a transfer of ownership of the first physical location indicated by the first candidate REO property data object to the second user.

In some embodiments, determining the first candidate REO property data object may further include accessing an REO property database comprising data entries indicative of a plurality of physical locations each of which are owned by the entity associated with the computing device. In such an embodiment, the method may include generating the first candidate REO property data object that is indicative of the first physical location from amongst the plurality of physical locations based upon the one or more first selection parameters and the one or more first user characteristics.

In other embodiments, determining the candidate REO property data object may further include accessing an REO property database comprising data entries indicative of a plurality of physical locations each of which are owned by the entity associated with the computing device. In such an embodiment, the REO property database may include the first candidate REO property data object indicative of the first physical location generated for the first user and a second candidate REO property data object indicative of the first physical location where the second candidate REO property data object is based upon one or more second selection parameters and one or more second user characteristics associated with a second user.

In some further embodiments, the method may include receiving the one or more corresponding first user inputs for effectuating the transaction that results in the transfer of ownership of the first physical location indicated by the first candidate REO property data object to the first user. The method may subsequently include precluding interaction with the second candidate REO property data object so as to prevent a transaction that results in a transfer of ownership of the first physical location to the second user.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates a system diagram including devices that may be involved in some example embodiments described herein.

FIG. 2 illustrates a schematic block diagram of example circuitry that may perform various operations, in accordance with some example embodiments described herein.

FIG. 3 illustrates an example flowchart property-based transactions, in accordance with some example embodiments described herein.

FIG. 4 illustrates an example flowchart for account database interactions, in accordance with some example embodiments described herein.

FIG. 5 illustrates an example flowchart for REO property database interactions, in accordance with some example embodiments described herein.

### DETAILED DESCRIPTION

Some embodiments of the present disclosure will now be described more fully hereinafter with reference to the accompanying drawings, in which some, but not all embodiments of the disclosure are shown. Indeed, these embodiments may be embodied in many different forms and should not be construed as limited to the embodiments set forth herein; rather, these embodiments are provided so that this disclosure will satisfy applicable legal requirements. Like numbers refer to like elements throughout. As used herein, the description may refer to a computing device as an example “apparatus.” However, elements of the apparatus described herein may be equally applicable to the claimed method and computer program product. Thus, use of any such terms should not be taken to limit the spirit and scope of embodiments of the present disclosure.

### Definition of Terms

As used herein, the terms “data,” “content,” “information,” “electronic information,” “signal,” “command,” and similar terms may be used interchangeably to refer to data capable of being transmitted, received, and/or stored in accordance with embodiments of the present disclosure. Thus, use of any such terms should not be taken to limit the spirit or scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, and/or the like, sometimes referred to herein as a “network.” Similarly, where a first computing device is described herein as sending data to a second computing device, it will be appreciated that the data may be sent directly to the second computing device or may be sent indirectly via one or more intermediary computing devices, such as, for example, one or more servers, remote servers, cloud-based servers (e.g., cloud utilities), relays, routers, network access points, base stations, hosts, and/or the like.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the word “example” is used herein to mean “serving as an example, instance, or illustration.” Any implementation described herein as “example” is not necessarily to be construed as preferred or advantageous over other implementations.

As used herein, the term “computing device” refers to computer hardware that is configured (either physically or by the execution of software) to generate, manage, and/or determined candidate REO property data objects and subsequently effectuate a property-based transaction with a user as described hereafter, and, among various other functions, is configured to directly, or indirectly, transmit and receive data. An example computing device may include a smartphone, a tablet computer, a laptop computer, a central server, a remote server, a wearable device (e.g., smart glasses, smart watch, or the like), and the like. In some embodiments, a computing device may include a “smart device” that is equipped with a chip or other electronic device that is configured to communicate with a first user device, a second user device, and/or a third user device via Bluetooth, NFC, Wi-Fi, 3G, 4G, 5G, RFID protocols, and the like. By way of a particular example, a computing device of the present disclosure may be a centralized server of an example financial institution with which user devices may transact and that may own REO properties.

As used herein, the terms “first user device,” “first mobile device,” “first electronic device,” and the like refer to computer hardware that is configured (either physically or by the execution of software) to access one or more services made available by the computing device (e.g., apparatus of the present disclosure) and, among various other functions, is configured to directly, or indirectly, transmit and receive data. Example first user devices may include a smartphone, a tablet computer, a laptop computer, a wearable device (e.g., smart glasses, smart watch, or the like), and the like. In some embodiments, a first user device may include a “smart device” that is equipped with a chip or other electronic device that is configured to communicate with the computing device and/or REO property database via Bluetooth, NFC, Wi-Fi, 3G, 4G, 5G, RFID protocols, and the like. By way of a particular example, a first user device may be a mobile phone equipped with a Wi-Fi radio associated with a first user that is configured to communicate with a Wi-Fi access point that is in communication with the computing device 200 or other computing device via a network.

The first user device may be associated with a first user that defines, includes, or is otherwise associated with one or more user characteristics of the first user. By way of example, the one or more user characteristics of the first user may include one or more data entries required for the first user to transact with the computing device (e.g., a central server of a financial institution or otherwise). As such, the user characteristics may include data entries associated with or indicative of the first user's name, identification number, account number, address, credit score, account balance, employment history, image, video, and/or any other feature, element, or item associated with the first user. The one or more first user characteristics may further be associated with or otherwise indicative of various characteristics of the first user that may affect or otherwise influence the first user's selection of real property. By way of a nonlimiting example, the one or more first user characteristics may include location data entries indicative of locations at which the first user is commonly located (e.g., a work address, current home address, family member's address, gym address, etc.), investment data entries indicative of the first user's savings, investments, etc., social media data indicative of the first user's preferences, opinions, etc., and/or the like. As described hereafter, the one or more user characteristics of the first user may be considered in determining an REO property (e.g., as provided in an REO property data object) for potential purchase by the first user.

As used herein, the terms “second user device,” “second mobile device,” “second electronic device,” and the like refer to computer hardware that is configured (either physically or by the execution of software) to access one or more services made available by the computing device (e.g., apparatus of the present disclosure) and, among various other functions, is configured to directly, or indirectly, transmit and receive data. Example second user devices may include a smartphone, a tablet computer, a laptop computer, a wearable device (e.g., smart glasses, smart watch, or the like), and the like. In some embodiments, a second user device may include a “smart device” that is equipped with a chip or other electronic device that is configured to communicate with the computing device and/or REO property database via Bluetooth, NFC, Wi-Fi, 3G, 4G, 5G, RFID protocols, and the like. By way of a particular example, a second user device may be a mobile phone equipped with a Wi-Fi radio associated with a second user that is configured to communicate with a Wi-Fi access point that is in communication with the computing device 200 or other computing device via a network.

The second user device may be associated with a second user that defines, includes, or is otherwise associated with one or more user characteristics of the second user. By way of example, the one or more user characteristics of the second user may include one or more data entries required for the second user to transact with the computing device (e.g., a central server of a financial institution or otherwise). As such, the user characteristics of the second user may include data entries associated with or indicative of the second user's name, identification number, account number, address, credit score, account balance, employment history, image, video, and/or any other feature, element, or item associated with the second user. The one or more second user characteristics may further be associated with or otherwise indicative of various characteristics of the second user that may affect or otherwise influence the second user's selection of real property. By way of a nonlimiting example, the one or more second user characteristics may include location data entries indicative of locations at which the second user is commonly located (e.g., a work address, current home address, family member's address, gym address, etc.), investment data entries indicative of the second user's savings, investments, etc., social media data indicative of the second user's preferences, opinions, etc., and/or the like. As described hereafter, the one or more user characteristics of the second user may be considered in determining an REO property (e.g., as provided in an REO property data object) for potential purchase by the second user.

As used herein, the terms “user account database” refer to a data structure or repository for storing data entries associated with one or more user characteristics. As defined above and described hereafter, users (e.g., a first user, a second user, etc.) may include or otherwise be associated with various user characteristics. In some embodiments, the computing device of the present disclosure may be configured to access the user account database in order to, for example, acquire user characteristics associated with various users. By way of a specific example, the computing device of the present disclosure may be associated with a financial institution (e.g., a central server of a bank or otherwise) such that the user account database refers to a data repository for storing data entries indicative of user characteristics of users that have accounts with the example financial institution.

As used herein, the terms “REO property database” refer to a data structure or repository for storing data entries associated with or indicative of one or more REO properties or physical locations owned by an entity (e.g., an example financial institution) associated with the computing device. As defined and described hereafter, candidate REO property data objects may be generated for particular physical locations and/or particular users so as to allow for the effectuation of a transaction that results in a transfer of ownership of these locations to respective users. As such, in some embodiments, the REO property database may provide an interface or other environment within which users may view, analyze, select, or otherwise interact with REO properties. By way of a particular example, the REO property database may be configured to be accessed by a first user device associated with the first user to view various REO properties owned by a financial institution associated with the REO property database and may further be configured to provide information (e.g., price, location, approved interest rate, etc.) that is specific to the first user. Said differently, the candidate REO property data objects that are displayed to a particular user via the REO property database may include data entries that are user-specific in that the particular candidate REO property data object may provide a mechanism for the specific user to effectuate a transaction (e.g., completion of user-specific valuation, underwriting, approval, etc. procedures for a particular user).

The terms “electronic data element,” “REO property data object,” “candidate REO property data object,” and/or the like refer to electronically-managed data that is generated by the computing device (e.g., apparatus, computing device, or central server of the present disclosure) and indicative of a physical location that is owned by an entity associated with the computing device. As described herein, the embodiments of the present disclosure may be configured to effectuate property-based transactions that reduce or otherwise minimize the computational burdens of the computing device. As such, in some embodiments, an example candidate REO property data object may be specific to a particular user in that the particular candidate REO property data object may provide a mechanism for the specific user to effectuate a transaction without further intermediary operations. For example, various processes or subprocesses (e.g., completion of user-specific valuation, underwriting, inspection, approval, etc.) for a particular user may be staged or otherwise completed and stored by the respective candidate REO property data object. In some further embodiments, the same candidate REO property data object may be similarly configured specific to a particular user, but available for a plurality of physical locations owned by the financial institution (e.g., entity associated with the example computing device). By way of a particular example, a first candidate REO property data object may be configured for effectuating a transfer of ownership of at least a first physical location (e.g., and, additionally or alternatively, a second physical location, a third physical location, etc.) for a first user.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Exemplary non-transitory computer-readable media may include, but are not limited to, one or more types of hardware memory, non-transitory tangible media (for example, one or more magnetic storage disks, one or more optical disks, one or more USB flash drives), computer system memory or random access memory (such as, DRAM, SRAM, EDO RAM), and the like.

Having set forth a series of definitions called-upon throughout this application, an example system architecture and example apparatus is described below for implementing example embodiments and features of the present disclosure.

### Device Architecture and Example Apparatus

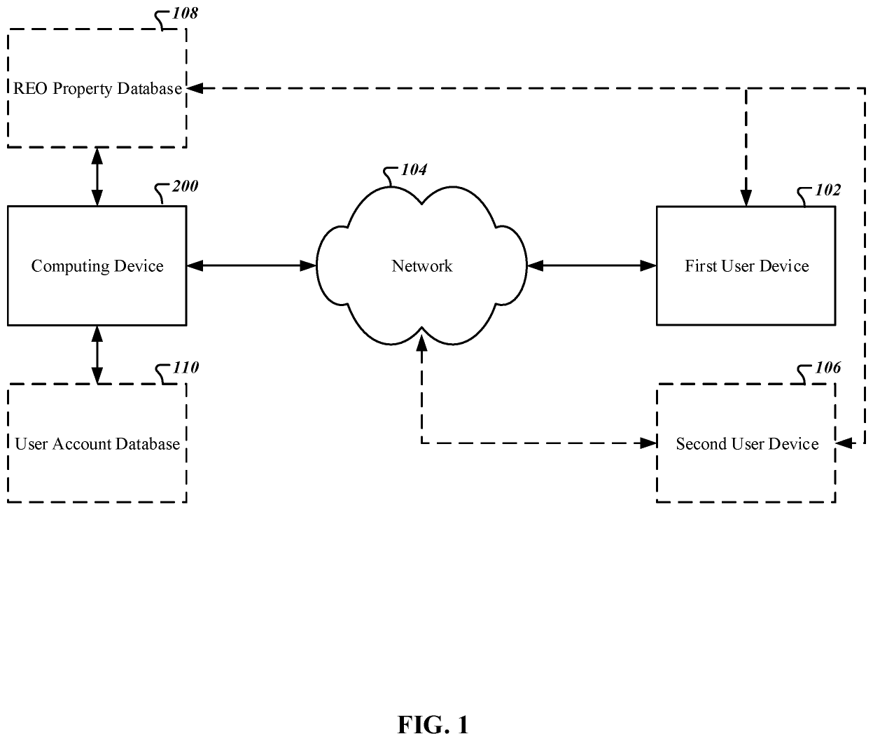

With reference to FIG. 1, an example system 100 is illustrated with an apparatus (e.g., a computing device 200) communicably connected via a network 104 to a first user device 102, and, in some embodiments, a second user device 106. Although illustrated with two user devices 102, 106, the present disclosure contemplates that the computing device 200 may be communicably connected with any number of user devices associated with the same or different users. The example system 100 may also include a user account database 110 that may be communicably coupled with the computing device 200. The example system 100 may further, in some embodiments, include an REO property database 108 that may be communicably coupled with the computing device 200, the first user device 102, and/or the second user device 106

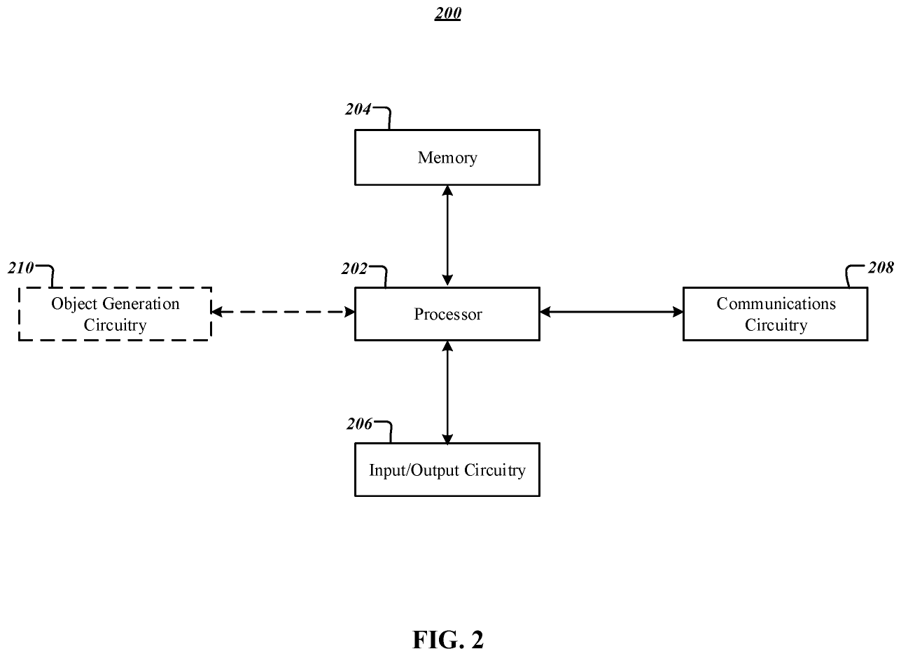

The computing device 200 may include circuitry, networked processors, or the like configured to perform some or all of the apparatus-based (e.g., computing device-based) processes described herein, and may be any suitable network server and/or other type of processing device. In this regard, computing device 200 may be embodied by any of a variety of devices. For example, the computing device 200 may be configured to receive data (e.g., selection parameter data, user characteristic data, etc.) and may include any of a variety of fixed terminals, such as a server, desktop, or kiosk, or it may comprise any of a variety of mobile terminals, such as a portable digital assistant (PDA), mobile telephone, smartphone, laptop computer, tablet computer, automated teller machine (ATM), or in some embodiments, a peripheral device that connects to one or more fixed or mobile terminals. Example embodiments contemplated herein may have various form factors and designs but will nevertheless include at least the components illustrated in FIG. 2 and described in connection therewith. In some embodiments, the computing device 200 may be located remotely from the first user device 102, second user device 106, REO property database 108, and/or user account database 110. In other embodiments, the computing device 200 may comprise the first user device 102, second user device 106, REO property database 108, and/or user account database 110. The computing device 200 may, in some embodiments, comprise several servers or computing devices performing interconnected and/or distributed functions. Despite the many arrangements contemplated herein, the computing device 200 is shown and described herein as a single computing device to avoid unnecessarily overcomplicating the disclosure.

The network 104 may include one or more wired and/or wireless communication networks including, for example, a wired or wireless local area network (LAN), personal area network (PAN), metropolitan area network (MAN), wide area network (WAN), or the like, as well as any hardware, software and/or firmware for implementing the one or more networks (e.g., network routers, switches, hubs, etc.). For example, the network 104 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the network 104 may include a public network, such as the Internet, a private network, such as an intranet, or combinations thereof, and may utilize a variety of networking protocols now available or later developed including, but not limited to TCP/IP based networking protocols.

The first user device 102 may be associated with a first user and may be configured to transact with the computing device 200. Although a single first user device 102 is shown in FIG. 1, the example system 100 may include any number of user devices associated with the first user. The first user device 102 may be a cellular telephone (including smartphones and/or other types of mobile telephones), laptop, tablet, electronic reader, e-book device, media device, wearable, smart glasses, smartwatch, VR device, AR device, or any combination of the above. The first user device 102 may be communicably coupled with the computing device 200 and/or the REO property database 108, via the network 104, and configured to transmit data to and receive data from the computing device 200 and/or the REO property database 108. By way of example, the first user device 102 may include a smartphone, mobile device, etc. configured to transmit a request for a property-based transaction to the computing device 200 and, in response to the operations described hereafter receive one or more corresponding first user inputs.

The second user device 106 may be associated with a second user and may be configured to transact with the computing device 200. Although a single second user device 106 is shown in FIG. 1, the example system 100 may include any number of user devices associated with the second user. The second user device 106 may be a cellular telephone (including smartphones and/or other types of mobile telephones), mobile device, laptop, tablet, electronic reader, e-book device, media device, wearable, smart glasses, smartwatch, VR device, AR device, or any combination of the above. The second user device 106 may be communicably coupled with the computing device 200 and/or the REO property database 108, via the network 104, and configured to transmit data to and receive data from the computing device 200 and/or the REO property database 108. By way of example, the second user device 106 may include a smartphone, mobile device, etc. configured to transmit a request for a property-based transaction to the computing device 200 and, in response to the operations described hereafter receive one or more corresponding second user inputs. As would be evident in light embodiments described hereinafter, the system 100 and/or computing device 200 may be configured for use with a plurality of user devices associated with any number of distinct or the same user(s) based upon the intended application of the system 100 and/or the computing device 200.

The REO property database 108 may be stored by any suitable storage device, memory structure, data repository, etc. configured to store some or all of the information described herein (e.g., a separate memory system separate from the computing device 200, such as one or more database systems, backend data servers, network databases, cloud storage devices, or the like). The REO property database 108 may comprise data received from the computing device 200 (e.g., via a memory 204 and/or processor(s) 202), the first user device 102 and/or the second user device 106 and the corresponding storage device may thus store this data. To avoid unnecessarily overcomplicating the disclosure, the REO property database 108 is shown and described as a separate database, despite the fact that they may each be hosted by any number of specific physical devices, together or separately. As defined above, the REO property database 108 may store one or more candidate REO property data objects.

The user account database 110 may be stored by any suitable storage device, memory structure, data repository, etc. configured to store some or all of the information described herein (e.g., a separate memory system separate from the computing device 200, such as one or more database systems, backend data servers, network databases, cloud storage devices, or the like). The user account database 110 may comprise data received from the computing device 200 (e.g., via a memory 204 and/or processor(s) 202), the first user device 102 and/or the second user device 106 and the corresponding storage device may thus store this data. To avoid unnecessarily overcomplicating the disclosure, the user account database 110 is shown and described as a separate database, despite the fact that they may each be hosted by any number of specific physical devices, together or separately. As defined above, the user account database 110 may store one or more user characteristics associated with respective users.

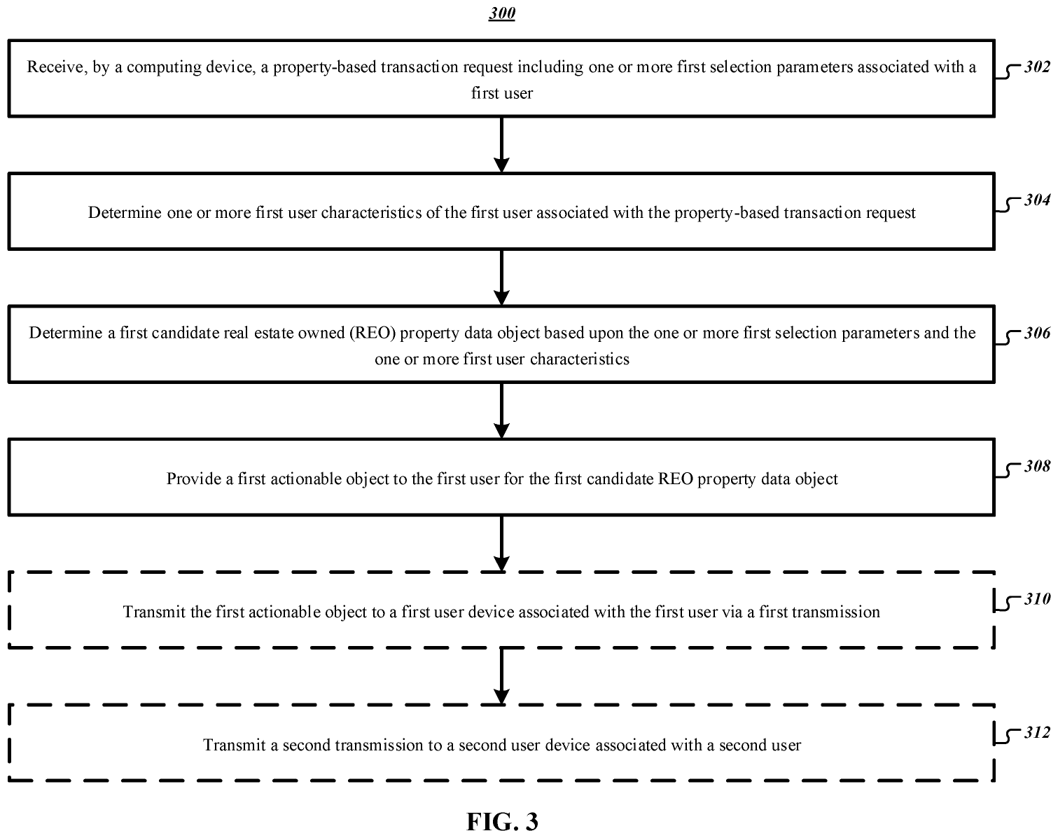

As illustrated in FIG. 2, the computing device 200 may include a processor 202, a memory 204, input/output circuitry 206, and communications circuitry 208. Moreover, computing device 200 may include object generation circuitry 210. The computing device 200 may be configured to execute the operations described below in connection with FIGS. 3-5. Although components 202-210 are described in some cases using functional language, it should be understood that the particular implementations necessarily include the use of particular hardware. It should also be understood that certain of these components 202-210 may include similar or common hardware. For example, two sets of circuitry may both leverage use of the same processor 202, memory 204, communications circuitry 208, or the like to perform their associated functions, such that duplicate hardware is not required for each set of circuitry. The use of the term “circuitry” as used herein includes particular hardware configured to perform the functions associated with respective circuitry described herein. As described in the example above, in some embodiments, various elements or components of the circuitry of the computing device 200 may be housed within one or more of the first user device 102 and/or the second user device 106. As indicated previously, it will be understood in this regard that some of the components described in connection with the computing device 200 may be housed within one of these devices, while other components are housed within another of these devices, or by yet another device not expressly illustrated in FIG. 1.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the computing device 200 may provide or supplement the functionality of particular circuitry.

In some embodiments, the processor 202 (and/or co-processor or any other processing circuitry assisting or otherwise associated with the processor) may be in communication with the memory 204 via a bus for passing information among components of the computing device 200. The memory 204 may be non-transitory and may include, for example, one or more volatile and/or non-volatile memories. In other words, for example, the memory may be an electronic storage device (e.g., a non-transitory computer readable storage medium). The memory 204 may be configured to store information, data, content, applications, instructions, or the like, for enabling the computing device to carry out various functions in accordance with example embodiments of the present disclosure.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the computing device, and/or remote or “cloud” processors.

In an example embodiment, the processor 202 may be configured to execute instructions stored in the memory 204 or otherwise accessible to the processor 202. Alternatively or additionally, the processor 202 may be configured to execute hard-coded functionality. As such, whether configured by hardware or by a combination of hardware with software, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

The computing device 200 further includes input/output circuitry 206 that may, in turn, be in communication with processor 202 to provide output to a user and to receive input from a user, user device, or another source. In this regard, the input/output circuitry 206 may comprise a display that may be manipulated by a mobile application. In some embodiments, the input/output circuitry 206 may also include additional functionality such as a keyboard, a mouse, a joystick, a touch screen, touch areas, soft keys, a microphone, a speaker, or other input/output mechanisms. The processor 202 may be configured to control one or more functions of a display through computer program instructions (e.g., software and/or firmware) stored on a memory accessible to the processor (e.g., memory 204, and/or the like), so as receive user attribute data and/or sensor data.

The communications circuitry 208 may be any means such as a device or circuitry embodied in either hardware or a combination of hardware and software that is configured to receive and/or transmit data from/to a network and/or any other device, circuitry, or module in communication with the computing device 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s). These signals may be transmitted by the computing device 200 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols.

Object generation circuitry 210 includes hardware components designed to determine and/or generate REO property data objects. For example, object generation circuitry 210 may include hardware components configured analyze user characteristic data and or selection parameter data to generate a respective REO property data object based upon the same. As described hereafter, the object generation circuitry 210 may be configured to stage or otherwise perform various operations, processes, and/or subprocesses (e.g., validation, authentication, underwriting, etc.) associated with a property-based transaction. Object generation circuitry 210 may utilize processing circuitry, such as the processor 202, to perform its corresponding operations, and may utilize memory 204 to store collected information. It should also be appreciated that, in some embodiments, the object generation circuitry 210 may include a separate processor, specially configured field programmable gate array (FPGA), or application specific interface circuit (ASIC) to perform its corresponding functions.

In addition, computer program instructions and/or other type of code may be loaded onto a computer, processor or other programmable computing device's circuitry to produce a machine, such that the computer, processor other programmable circuitry that execute the code on the machine create the means for implementing the various functions, including those described in connection with the components of computing device 200.

As described above and as will be appreciated based on this disclosure, embodiments of the present disclosure may be configured as systems, methods, mobile devices, and the like. Accordingly, embodiments may comprise various means including entirely of hardware or any combination of software with hardware. Furthermore, embodiments may take the form of a computer program product comprising instructions stored on at least one non-transitory computer-readable storage medium (e.g., computer software stored on a hardware device). Any suitable computer-readable storage medium may be utilized including non-transitory hard disks, CD-ROMs, flash memory, optical storage devices, or magnetic storage devices.

### Example Operations for Property-Based Transactions

FIG. 3 illustrates a flowchart containing a series of operations for property-based transactions. The operations illustrated in FIG. 3 may, for example, be performed by, with the assistance of, and/or under the control of an apparatus (e.g., computing device 200), as described above. In this regard, performance of the operations may invoke one or more of processor 202, memory 204, input/output circuitry 206, communications circuitry 208, and/or object generation circuitry 210.

As shown in operation 302, the apparatus (e.g., computing device 200) includes means, such as input/output circuitry 206, communications circuitry 208, or the like, for receiving, by the computing device 200, a property-based transaction request associated with a first user. As described above, the computing device 200 of the present disclosure may be associated with, for example, a financial institution (e.g., a central server of a financial institution or otherwise) such that the request for a property-based transaction may refer to a request by the first user for financing, funding, etc. by the financial institution (e.g., the entity) associated with the computing device 200. In such an embodiment, the first user may transmit a request to the computing device at operation 302 via interactions with a web-based application of the computing device (e.g., an online mortgage application), via an application form that is transmitted from the first user device 102 to the computing device, or the like. By way of an additional example, the request at operation 302 may, in some embodiments, refer to a request by the first user at a branch location, automated teller machine (ATM), or the like for a property-based transaction that may be received by the computing device 200 via an input by the first user at the ATM, via a teller at the branch location, etc. In other words, the request at operation 302 may, in some embodiments, refer to an explicit request by the first user, via the first user device 102 or otherwise, to request a property-based transaction that includes the entity associated with the computing device 200.

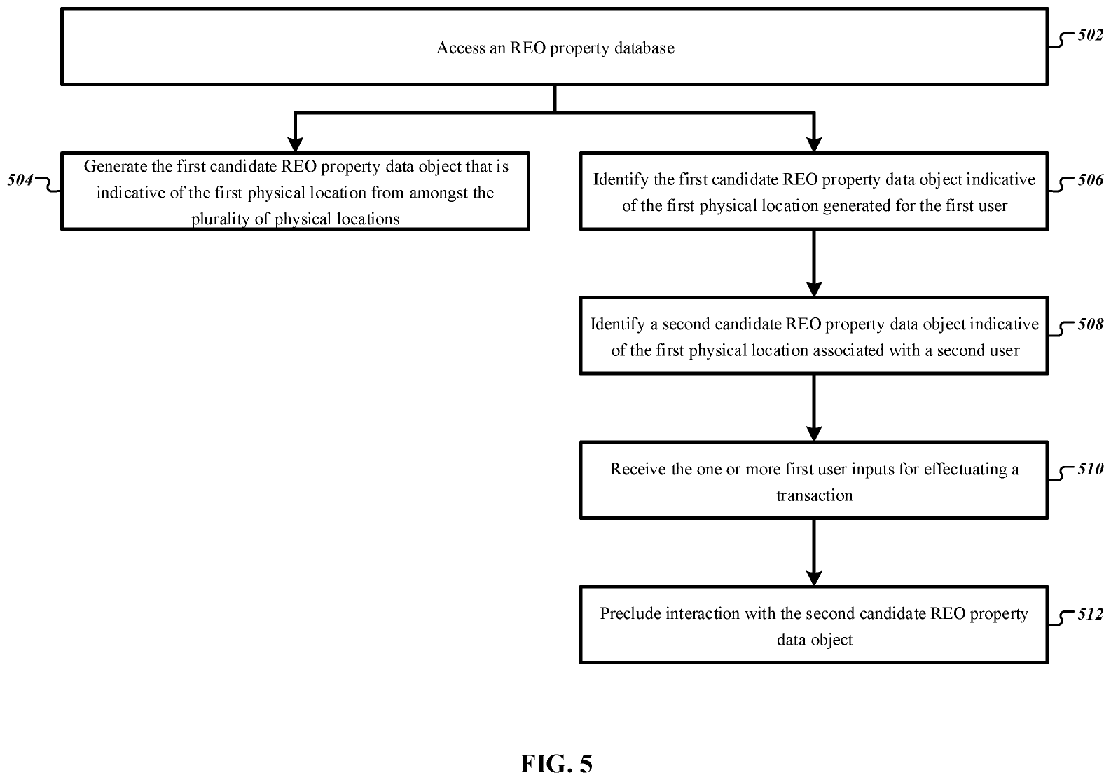

Additionally or alternatively, in some embodiments, the request received at operation 302 may be implicit in that the first user may not actively indicate that the property-based transaction is to be fulfilled by the entity associated with the computing device 302 at the time at which the request is received. By way of example, the first user may access a service offered by the computing device 200 that lists example mortgage interest rates, refinance interest rates, or the like such that the request for a property-based transaction received at operation 302 may not be tied to a particular real property asset at the time at which the request is received. By way of an additional example described hereinafter with reference to FIG. 5, the first user may access the REO property database 108, via the first user device 102, such that the request at operation 302 is received as a result of this interaction. For example, the REO property database 108 may provide an interface or other environment within which users (e.g., the first user) may view, analyze, select, or otherwise interact with REO properties. By way continued example, the REO property database 108 may be configured to be accessed by a first user device 102 associated with the first user to view various REO properties owned by a financial institution (e.g., the entity) associated with the REO property database 108. As such, the request for a property-based transaction received at operation 302 may occur due at least in part to an interaction by the first user with the REO property database 108 (e.g., selecting a particular REO property, identifying a location of interest, inputting a particular price range, etc.).

Although described herein with reference to explicit and implicit interactions, the present disclosure contemplates that the request for a property-based transaction may be received by the computing device 200 by any mechanism without limitation. For example, an entity associated with the computing device 200 (e.g., an example financial institution or the like) may identify one or more users, including the first user, for potentially purchasing an REO property. As such, the operations described hereinafter regarding determining REO property data objects for the example first user may include implementations in which the entity associated with the computing device 200 proactively provides the REO data object to the first user absent a specific request by the first user. Said differently, the present disclosure contemplates that receiving a property-based transaction request at operation 302 may equally refer to an internal determination by the computing device 200 that ultimately results in a REO property data object being provided to the first user.

The property-based transaction request received at operation 302 may also include one or more first selection parameters. As described above, the request for the property-based transaction may be received by the computing device 200 in response to actions on behalf or by the first user, via the first user device 102 or otherwise. In some embodiments, this request may include data entries indicative of or otherwise associated with a real property asset or plurality of real property assets that the first user may purchase. By way of continued example, the first user may transmit a request to the entity (e.g., financial institution or the like) associated with the computing device 200 requesting a property-based transaction in the form of a request for funding or financing that includes a requested amount, property location, etc. (e.g., one or more selection parameters). In other embodiments, the first user may input a zip code, address, tax value, appraised value, mortgage amount, etc. (e.g., one or more selection parameters) via interactions with a service or application of the computing device 200. By way of an additional example, in some embodiments, the first user may interact with the REO property database 108 by selecting or otherwise viewing various REO properties stored, hosted, or otherwise accessible via the REO property database 108. The parameters (e.g., location, price, etc.) of these accessed REO properties of the REO property database 108 may operate as a source of the one or more selection parameters received at operation 302.

Thereafter, as shown in operation 304, the apparatus (e.g., computing device 200) includes means, such as processor 202, communications circuitry 208, or the like, for determining one or more first user characteristics of the first user associated with the property-based transaction request. As defined above, the one or more user characteristics of the first user may include one or more data entries required for the first user to transact with the computing device 200. As such, the user characteristics of the first user may include data entries associated with or indicative of the first user's name, identification number, account number, address, credit score, account balance, employment history, image, video, and/or any other feature, element, or item associated with the first user. The one or more first user characteristics may further be associated with or otherwise indicative of various characteristics of the first user that may affect or otherwise influence the first user's selection of real property. By way of a nonlimiting example, the one or more first user characteristics may include location data entries, investment data entries, social media data entries, and/or the like and may refer to any parameters, element, feature, or the like related to property-based transactions.

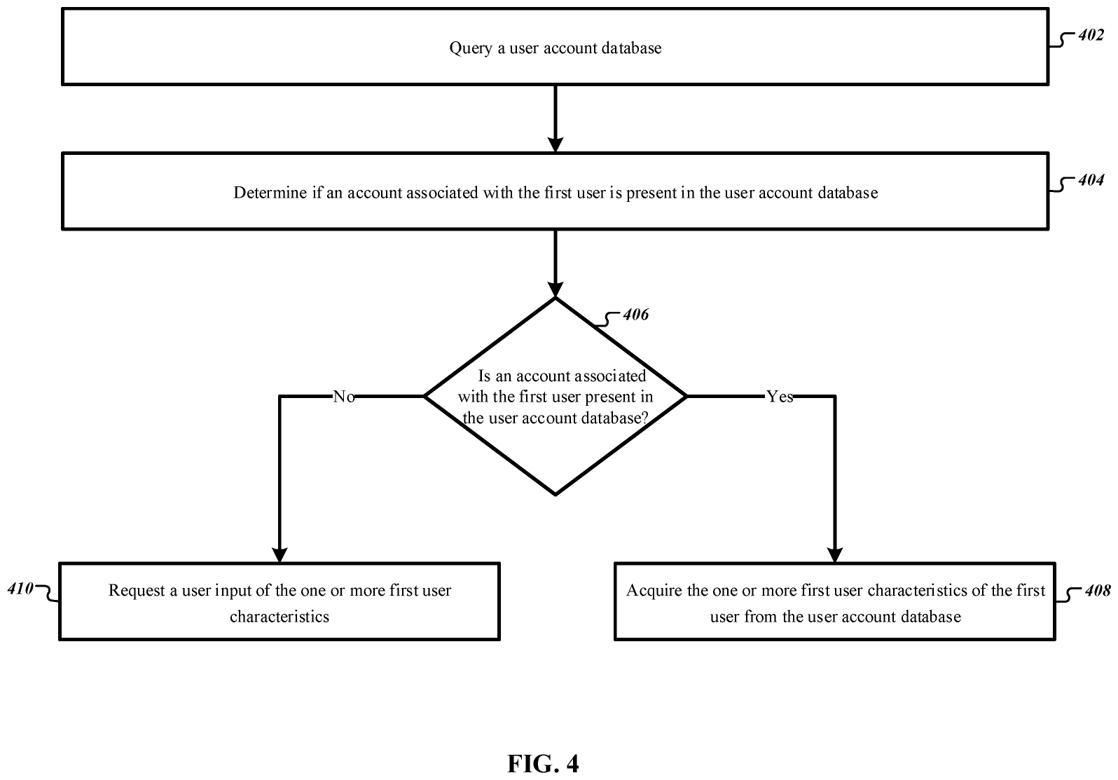

As described hereafter with reference to FIG. 4, in some embodiments, the first user may in some embodiments, be associated with or otherwise interact with the entity (e.g., financial institution or the like) associated with the computing device 200, such as by being a current customer of the entity. By way of example, in some embodiments, the first user may have a financial account with the entity associated with the computing device 200. As described further hereafter, the computing device 200 may be configured to query a user account database 110 in order to acquire one or more first user characteristics associated with the first user. In some instances, the computing device 200 may not identify an account of the first user in the user account database 110 and may, in turn, transmit a request to the first user (e.g., the first user device 102) in order to prompt the first user to provide the one or more first user characteristics.

Thereafter, as shown in operation 306, the apparatus (e.g., computing device 200) includes means, such as processor 202, communications circuitry 208, object generation circuitry 210, or the like, for determining a first candidate real estate owned (REO) property data object based upon the one or more first selection parameters and the one or more first user characteristics. As described above, the request for the property-based transaction associated with the first user may be, for example, indicative of the first user's interest in purchasing a real property asset (e.g., a house, condo, townhome, real estate, etc.). Given that the computing device 200 is associated with an entity (e.g., financial institution or the like) that owns physical locations, real estate, etc. in the form of REO properties, the computing device at operation 306 may operate to identify an REO property that is indicative of a first physical location that is owned by an entity (e.g., financial institution or the like) associated with the computing device 200. This determination may account for the one or more first selection parameters described above as well as the one or more first user characteristics such that the first physical location identified by the computing device 200 satisfies one or more of the requirements (e.g., the first selection parameters) of the first user with regard to the real property asset (e.g., REO property) while also accounting for the ability of the first user to purchase this asset (e.g., based upon the one or more first user characteristics).

The determination of the first candidate REO property data object may, for example, refer to the generation of the first candidate REO property data object such that the first user may effectuate a transaction that results in a transfer of ownership of the first physical location indicated by the first candidate REO property data object to the first user. As described above, the entity (e.g., financial institution or the like) associated with the computing device 200 may be uniquely positioned to reduce the burden associated with property-based transactions for customers due to this entity's access to user financial data (e.g., user characteristics) so as to stage or complete processes or subprocesses associated with the transaction in determining the first candidate REO property data object. For example, the computing device 200 at operation 306 may perform validation operations, authentication operations, underwriting operations, approval operations, and/or any process required to effectuate a real property transaction. As such, as described hereafter, an input by the first user to purchase this real property asset (REO property) may occur without further requirements on the part of the first user. In some embodiments, the determination of the first candidate REO property data object may be associated with a single physical location such that interaction with the first candidate REO property data object is limited to transactions with this single physical location. In other embodiments, however, the computing device 200 may further operate to reduce or minimize the computational load of the system of the first REO property data object by performing the necessary operations for plurality of physical locations and storing the outcome of these determinations in a common data object (e.g., the first candidate REO property data object). In doing so, the first user may, via interaction with the same REO property data object purchase one of a plurality of REO properties owned by the entity (e.g., financial institution or otherwise) of the computing device 200.

Thereafter, as shown in operation 308, the apparatus (e.g., computing device 200) includes means, such as processor 202, communications circuitry 208, object generation circuitry 210, or the like, for providing a first actionable object to the first user for the first candidate REO property data object. The first actionable object may include one or more selectable inputs configured to receive one or more corresponding first user inputs for effectuating a transaction that results in a transfer of ownership of the first physical location indicated by the first candidate REO property data object to the first user. By way of example, in some embodiments, the first actionable object may include a notification that is provided to the first user in order for the first user to confirm or deny a desire to purchase the first physical location. For example the first actionable object may include a plurality of inputs (e.g., buttons, free text inputs, etc.) with which the first user may select to purchase an REO property (e.g., the first physical location). As described above, the computing device 200 may be configured to perform various processes and/or subprocesses (e.g., validation, authentication, underwriting, valuation, etc.) as part of determining or generating the first candidate REO property data object such that a corresponding first user input for effectuating the transaction may result in a transfer of ownership of the first physical location indicated by the first candidate REO property data object to the first user in substantially real-time and/or with limited or absent further interaction on the part of the first user. In some embodiments in which the first candidate REO property data object is associated with a plurality of physical locations (e.g., first physical location, second physical location, etc.) owned by the entity (e.g., financial institution or the like) of the computing device 200, the one or more selectable inputs of the first actionable object may allow for corresponding inputs from the first user to select one of a plurality of physical locations.

Thereafter, in some embodiments as shown in operation 310, the apparatus (e.g., computing device 200) includes means, such as processor 202, communications circuitry 208, object generation circuitry 210, or the like, for transmitting the first actionable object to a first user device 102 associated with the first user via a first transmission. By way of continued example, the request for a property-based transaction at operation 302 may be received from the first user device 102 of the first user. In such an embodiment, the first actionable object may be provided to the first user at operation 310 via the generation of a first transmission by the computing device 200 that includes the first actionable object and transmitting the first transmission to the first user device 102 for interaction by the first user as described above.

Thereafter, in some embodiments as shown in operation 312, the apparatus (e.g., computing device 200) includes means, such as processor 202, communications circuitry 208, object generation circuitry 210, or the like, for transmitting a second transmission to a second user device 106 associated with a second user. The second transmission, for example, may include instructions to preclude input of one or more second user inputs via a second actionable object so as to prevent a transaction that results in a transfer of ownership of the first physical location indicated by the first candidate REO property data object to the second user. As described hereafter with reference to FIG. 5, in some embodiments, a plurality of users (e.g., at least the first user and the second user) may access a plurality of REO properties owned by the entity (e.g., financial institution or otherwise) of the computing device 200, such as via the REO property database 108. As such, the computing device 200 may generate respective candidate REO property data objects for review by the respective first and second users in parallel or otherwise. As such, selection of the one or more selectable inputs by the first user for effectuating the transaction that results in a transfer of ownership of the first physical location indicated by the first candidate REO property data object to the first user may result in preventing the second user from attempting to purchase the same underlying physical location (e.g., the first physical location). As such, at operation 312, a second transmission may be provided to an example second user device 106 that prevents the second user from attempting to also purchase the first physical location (e.g., the same REO property). Although described herein with reference to a second user with an associated second user device 106, the present disclosure contemplates that any number of transmissions may be provided to respective user devices that prevent the purchase of the first physical location in response to operation 308.

In any embodiment, an example transmission providing an actionable object that includes an associated candidate REO property data object may further include one or more timing limitations. Such a timing limitation may, for example, be indicative of or otherwise provide a time period during which interaction with the actionable data object is provided and/or outside of which interaction with the actionable data object may be limited. By way of example, the first actionable object provided to the first user at operation 308 may include timing limitations that provide a time period (e.g., one hour, one day, one week, etc.) during which the first user is capable of interacting with the first actionable object (e.g., so as to potentially purchase the underlying REO property associated with the object). The present disclosure contemplates that any number of timing limitations may be included with any number of actionable objects and that these timing limitations may be, for example, interdependent (e.g., a second timing limitation that depends from a first timing limitation or the like) based upon the intended application of the embodiments described herein.

FIG. 4 illustrates a flowchart containing a series of operations for account database interactions. The operations illustrated in FIG. 4 may, for example, be performed by, with the assistance of, and/or under the control of an apparatus (e.g., computing device 200), as described above. In this regard, performance of the operations may invoke one or more of processor 202, memory 204, input/output circuitry 206, communications circuitry 208, and/or object generation circuitry 210.

As shown in operation 402, the apparatus (e.g., computing device 200) includes means, such as input/output circuitry 206, communications circuitry 208, or the like, for querying a user account database. As defined above, users (e.g., a first user, a second user, etc.) may include or otherwise be associated with various user characteristics. In some embodiments, the computing device 200 of the present disclosure may be configured to access the user account database in order to, for example, acquire user characteristics associated with various users. By way of a specific example, the computing device 200 of the present disclosure may be associated with a financial institution (e.g., a central server of a bank or otherwise) such that the user account database refers to a data repository for storing data entries indicative of user characteristics of users that have accounts with the example financial institution.

As shown in operations 404, 406, the apparatus (e.g., computing device 200) includes means, such as processor 202, communications circuitry 208, or the like, for determining if an account associated with the first user is present in the user account database 110. By way of example, the first user may be associated with a username, account name, account number, identification number, etc. (e.g., user characteristic(s)) that may be, for example, provided to the computing device 200 via the request for the property-based transaction. The computing device 200 may operate to compare the, for example, account number of the first user with the plurality of account numbers stored by the user account database 110 in order to determine if an account associated with the first user present in the user account database 110.

In an instance in which the account associated with the first user is present in the user account database 110, as shown in operation 408, the apparatus (e.g., computing device 200) includes means, such as processor 202, communications circuitry 208, or the like, for acquiring the one or more first user characteristics of the first user from the user account database 110. For example, the computing device 200 may receive a transmission from the user account database 110 that includes the one or more user characteristics of the first user. In instances in which the computing device 200 comprises the user account database 110, operation 408 may refer to an internal transmission of the like. In an instance in which the account associated with the first user is present in the user account database 110, as shown in operation 410, the apparatus (e.g., computing device 200) includes means, such as processor 202, communications circuitry 208, or the like, for requesting a user input of the one or more first user characteristics. By way of example, the computing device 200 may transmit a request to the first user device 102 that requests one or more user inputs of the first user characteristics of the first user.

FIG. 5 illustrates a flowchart containing a series of operations for REO property database interactions. The operations illustrated in FIG. 5 may, for example, be performed by, with the assistance of, and/or under the control of an apparatus (e.g., computing device 200), as described above. In this regard, performance of the operations may invoke one or more of processor 202, memory 204, input/output circuitry 206, communications circuitry 208, and/or object generation circuitry 210.

As shown in operation 502, the apparatus (e.g., computing device 200) includes means, such as input/output circuitry 206, communications circuitry 208, or the like, for accessing the REO property database 108 comprising data entries indicative of a plurality of physical locations each of which are owned by the entity (e.g., financial institution or the like) associated with the computing device 200. As described above, candidate REO property data objects may be generated for particular physical locations and/or particular users so as to allow for the effectuation of a transaction that results in a transfer of ownership of these locations to respective users. As such, in some embodiments, the REO property database 108 may provide an interface or other environment within which users (e.g., a first user, a second user, a third user, . . . , etc.) may view, analyze, select, or otherwise interact with REO properties. As such, the computing device 200 at operation 502 may access the REO property database 108 in determination of the first candidate REO property data object so as to acquire first selection parameters of the first user as described above with reference to operation 302. As would be evident in light of the present disclosure, the interface or environment viewed by a particular user (e.g., first user, second user, third user, . . . , etc.) may be user-specific or otherwise differ in presentation for different users. By way of example, the interface presented to a first user may be generated based upon one or more characteristics of the first user, and the interface presented to the second user may be generated based upon one or more characteristics of the second user. As such, each candidate REO property data object presented by such an interface may differ based upon the user to which the candidate REO property data object is presented (e.g., a higher price, a lower interest rate, lower closing costs, etc. based upon the respective characteristics of the first and the second user).

In some embodiments, as shown in operation 504, the apparatus (e.g., computing device 200) includes means, such as processor, object generation circuitry 210, or the like, for generating the first candidate REO property data object that is indicative of the first physical location from amongst the plurality of physical locations based upon the one or more first selection parameters and the one or more first user characteristics. In such an embodiment, providing the first candidate REO property data object as described above with reference to FIG. 3 may be reactive or otherwise in response to the request for the property-based transaction at operation 302 above. Said differently, in some embodiments, the first candidate REO property data object may be generated for a plurality of physical locations within the REO property database 108, for a plurality of users, etc. As such, the first candidate REO property data object is provided to the first user in such an embodiment. In other embodiments, as shown in operation 504, the generation of the first candidate REO property data object may occur responsive to the request at operation 302 in that the first candidate REO property data object is generated in real-time based upon the first user's interactions with the REO property database 108.

In other embodiments, as shown in operations 506, 508, the apparatus (e.g., computing device 200) includes means, such as processor, object generation circuitry 210, or the like, for identifying the first candidate REO property data object indicative of the first physical location generated for the first user and identifying a second candidate REO property data object indicative of the first physical location associated with a second user. By way of continued example, the REO property database 108 may be configured to be accessed by a first user device 102 associated with the first user to view various REO properties owned by a financial institution (e.g., the entity) associated with the REO property database and may further be configured to provide information (e.g., price, location, approved interest rate, etc.) that is specific to the first user (e.g., a first candidate REO property data object specific to the first user that includes at least the first physical location). Similarly, the REO property database 108 may be configured to be accessed by a second user device 106 associated with the second user to view various REO properties owned by a financial institution (e.g., the entity) associated with the REO property database and may further be configured to provide information (e.g., price, location, approved interest rate, etc.) that is specific to the second user (e.g., a second candidate REO property data object specific to the second user that includes at least the first physical location). In this way, the first and the second candidate REO property data objects may allow either the first user or the second user to efficiently effectuate transfer of ownership of the first physical location without or with reduced further effort by the first user or the second user.

Thereafter, as shown in operations 510, 512, the apparatus (e.g., computing device 200) includes means, such as processor, object generation circuitry 210, or the like, for receiving the one or more corresponding first user inputs for effectuating the transaction that results in the transfer of ownership of the first physical location indicated by the first candidate REO property data object to the first user and precluding interaction with the second candidate REO property data object so as to prevent a transaction that results in a transfer of ownership of the first physical location to the second user. As described above with reference to operations 310, 312, the computing device 200 may receive an input, such as via the first actionable object, from the first user that indicates a selection to effectuate transfer of ownership of the example first physical location. As such, the computing device 200 may operate to prevent or preclude the ability of other users (e.g., the second user) from attempting to effectuate a transfer of ownership of the same first physical location. Given that the computing device 200 interacts with a plurality of users and owns a plurality of REO properties, the operations of FIG. 5 may provide dynamic parallel offer implementations in which candidate REO property data objects for each of a plurality of users are modified in real-time based upon interactions by other users with respective candidate REO property data objects.

As described above, various technical challenges are surmounted via technical solutions contemplated herein. For example, implementations of embodiments of the present disclosure may generate and maintain candidate real estate owned (REO) property data objects for particular users and/or for a plurality of properties (e.g., REO properties owned by an entity of the present disclosure). In operation, the embodiments described herein may receive property-based transaction requests from a plurality of users each of which may include selection parameters that are indicative of a type, value, location, etc. associated with a real property asset. One or more characteristics of the requesting user (e.g., net worth, credit score, etc.) may be determined, and a respective REO property data object may be generated that is indicative of a physical location that is owned by an entity associated with the described system. The REO property data object of the present disclosure may operate to store, perform, stage, or otherwise complete necessary processes or subprocesses for effectuating a property-based transaction that transfers ownership of the associated physical location indicated by the first candidate REO property data object to the appropriate user. In doing so, the embodiments described herein may reduce the computational burdens (e.g., processing limitations, memory requirements, etc.) associated with traditional systems. Furthermore, the REO property data objects described herein may operate to offload or otherwise expeditiously attend to the selling of REO properties that would otherwise require additional resources to maintain. Still further, by providing REO property data objects to a plurality of users associated with the same or different underlying physical locations, the embodiments described herein may operate to minimize the time require for a particular user to purchase a property by, in parallel, precluding transactions by other users.

In this way, the inventors have identified that the advent of computing resources have created a new opportunity for solutions for property-based transactions and associated data storage which were historically unavailable. In particular, the embodiments herein may operate to address several technical challenges including: (1) minimizing the computational burden of payment system, (2) minimizing operating time for payment based processes and subprocesses, and (3) providing dynamically modifiable data objects for transitioning ownership of real property assets, particularly those owned by the underlying entity associated with the system.

FIGS. 3-5 thus illustrate flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 204 of the computing device 200 and executed by a processor 202 of the computing device 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

### Conclusion

Many modifications and other embodiments of the disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method comprising:
receiving, by a computing device, a property-based transaction request associated with a first user, wherein the property-based transaction request comprises one or more first selection parameters;
determining one or more first user characteristics of the first user associated with the property-based transaction request;
determining a first candidate real estate owned (REO) property data object based upon the one or more first selection parameters and the one or more first user characteristics, wherein the first candidate REO property data object is indicative of a first physical location that is owned by an entity associated with the computing device, including:
accessing an REO property database comprising data entries indicative of a plurality of physical locations, each of which is owned by the entity associated with the computing device, wherein the REO property database comprises at least:
the first candidate REO property data object indicative of the first physical location generated for the first user; and
a second candidate REO property data object indicative of the first physical location, wherein the second candidate REO property data object is based upon one or more second selection parameters and one or more second user characteristics associated with a second user;
performing an operation associated with a transaction that results in a transfer of ownership of the first physical location indicated by the first candidate REO property data object to the first user;
storing a stage of the operation or completion of the operation in the first candidate REO property data object;
providing a first actionable object to the first user for the first candidate REO property data object, wherein the first actionable object comprises one or more selectable inputs configured to receive one or more corresponding first user inputs for effectuating the transaction that results in the transfer of ownership of the first physical location indicated by the first candidate REO property data object to the first user;
receiving the one or more corresponding first user inputs for effectuating the transaction that results in the transfer of ownership of the first physical location indicated by the first candidate REO property data object to the first user; and
precluding, in response to the transaction that results in the transfer of ownership, interaction with the second candidate REO property data object so as to prevent a second transaction that results in a transfer of ownership of the first physical location to the second user.

2. The computer-implemented method according to claim 1, wherein determining the one or more first user characteristics of the first user associated with the property-based transaction request further comprises:
querying a user account database;
determining if an account associated with the first user is present in the user account database;
in an instance in which the account associated with the first user is present in the user account database, acquiring the one or more first user characteristics of the first user from the user account database; and
in an instance in which the account associated with the first user is absent from the user account database, requesting a user input of the one or more first user characteristics.

3. The computer-implemented method according to claim 1, wherein providing the first actionable object to the first user further comprises transmitting the first actionable object to a first user device associated with the first user via a first transmission.

4-7. (canceled)

8. An apparatus for property-based transactions comprising at least one processor and at least one memory, the at least one memory having computer-code instructions stored thereon that, in execution with the at least one processor, configure the apparatus to:
receive a property-based transaction request associated with a first user, wherein the property-based transaction request comprises one or more first selection parameters;
determine one or more first user characteristics of the first user associated with the property-based transaction request;
determine a first candidate real estate owned (REO) property data object based upon the one or more first selection parameters and the one or more first user characteristics, wherein the first candidate REO property data object is indicative of a first physical location that is owned by an entity associated with the apparatus, including:
access an REO property database comprising data entries indicative of a plurality of physical locations, each of which is owned by the entity associated with the apparatus, wherein the REO property database comprises at least:
the first candidate REO property data object indicative of the first physical location generated for the first user; and
a second candidate REO property data object indicative of the first physical location, wherein the second candidate REO property data object is based upon one or more second selection parameters and one or more second user characteristics associated with a second user;
perform an operation associated with a transaction that results in a transfer of ownership of the first physical location indicated by the first candidate REO property data object to the first user;
store a stage of the operation or completion of the operation in the first candidate REO property data object;
provide a first actionable object to the first user for the first candidate REO property data object, wherein the first actionable object comprises one or more selectable inputs configured to receive one or more corresponding first user inputs for effectuating the transaction that results in the transfer of ownership of the first physical location indicated by the first candidate REO property data object to the first user;
receive the one or more corresponding first user inputs for effectuating the transaction that results in the transfer of ownership of the first physical location indicated by the first candidate REO property data object to the first user; and
preclude, in response to the transaction that results in the transfer of ownership, interaction with the second candidate REO property data object so as to prevent a second transaction that results in a transfer of ownership of the first physical location to the second user.

9. The apparatus according to claim 8, wherein, in determining the one or more first user characteristics of the first user associated with the property-based transaction request, the apparatus is further configured to:
query a user account database;
determine if an account associated with the first user is present in the user account database;
in an instance in which the account associated with the first user is present in the user account database, acquire the one or more first user characteristics of the first user from the user account database; and
in an instance in which the account associated with the first user is absent from the user account database, request a user input of the one or more first user characteristics.

10. The apparatus according to claim 8, wherein, in providing the first actionable object to the first user, the apparatus is further configured to transmit the first actionable object to a first user device associated with the first user via a first transmission.

11-14. (canceled)

15. A computer program product for property-based transactions comprising at least one non-transitory computer-readable storage medium having computer program code thereon that, in execution with at least one processor, configures the computer program product for:
receiving a property-based transaction request associated with a first user, wherein the property-based transaction request comprises one or more first selection parameters;
determining one or more first user characteristics of the first user associated with the property-based transaction request;
determining a first candidate real estate owned (REO) property data object based upon the one or more first selection parameters and the one or more first user characteristics, wherein the first candidate REO property data object is indicative of a first physical location that is owned by an entity associated with the computer program product, including:
accessing an REO property database comprising data entries indicative of a plurality of physical locations, each of which is owned by the entity associated with the computer program product, wherein the REO property database comprises at least:
the first candidate REO property data object indicative of the first physical location generated for the first user; and
a second candidate REO property data object indicative of the first physical location, wherein the second candidate REO property data object is based upon one or more second selection parameters and one or more second user characteristics associated with a second user;
performing an operation associated with a transaction that results in a transfer of ownership of the first physical location indicated by the first candidate REO property data object to the first user;
storing a stage of the operation or completion of the operation in the first candidate REP property data object;
providing a first actionable object to the first user for the first candidate REO property data object, wherein the first actionable object comprises one or more selectable inputs configured to receive one or more corresponding first user inputs for effectuating the transaction that results in the transfer of ownership of the first physical location indicated by the first candidate REO property data object to the first user;
receiving the one or more corresponding first user inputs for effectuating the transaction that results in the transfer of ownership of the first physical location indicated by the first candidate REO property data object to the first user; and
precluding, in response to the transaction that results in the transfer of ownership, interaction with the second candidate REO property data object so as to prevent a second transaction that results in a transfer of ownership of the first physical location to the second user.

16. The computer program product according to claim 15, in determining the one or more first user characteristics of the first user associated with the property-based transaction request, is further configured for:
querying a user account database;
determining if an account associated with the first user is present in the user account database;
in an instance in which the account associated with the first user is present in the user account database, acquiring the one or more first user characteristics of the first user from the user account database; and
in an instance in which the account associated with the first user is absent from the user account database, requesting a user input of the one or more first user characteristics.

17. The computer program product according to claim 15, in providing the first actionable object to the first user, is further configured for transmitting the first actionable object to a first user device associated with the first user via a first transmission.

18-20. (canceled)
